(19) United States
(12) Patent Application Publication
(10) Pub. No.: US 2020/0307340 A1
(43) Pub. Date: Oct. 1, 2020

(54) Active Shock Absorbing In OffRoad Vehicles

(71) Applicant: Zhejiang CFMOTO Power Co., Ltd., Hangzhou (CN)

(72) Inventor: Xiaofeng YAO, Hangzhou (CN)

(21) Appl. No.: 16/506,341

(22) Filed: Jul. 9, 2019

(30) Foreign Application Priority Data
Mar. 25, 2019 (CN) 201910227911.0

(51) Int. Cl. B60G 17/019; B60G 17/016; B60G 17/06

(52) U.S. Cl. CPC B60G 17/01908; B60G 17/0164; B60G 2500/10; B60G 2400/41; B60G 17/06

(57) ABSTRACT

A method and system controls active shock absorbers in an off road vehicle. X- Y- and Z-signals from at least one accelerometer sensor are received and analyzed in an ECU to make a vehicle travel status assessment. A recent history of Y-signals is analyzed to determine a vibration frequency of the vehicle relative to its natural suspension frequency. By using either a) two 3-axis accelerometer sensors are positioned high on the frame along a centerline of the vehicle, or b) a single accelerometer sensor is positioned just underneath the driver's seat, the cost of implementation is reduced while protecting the accelerometer sensor(s) from damage. In addition to vibration frequency, the ECU can determine the onset and conclusion an acceleration event, a deceleration event, a cornering event, or a jumping event, outputting signals used to adjust the damping coefficient of each of the active shock absorbers.

### CROSS-REFERENCE TO RELATED U.S. APPLICATION(S)

None.

### FIELD OF THE INVENTION

The present invention relates to offroad vehicles such as UVs and ATVs, and more particularly to the design of systems to control the damping characteristics of adjustable shock absorbers in such offroad vehicles.

### BACKGROUND OF THE INVENTION

Utility vehicles (“UVs”) and all terrain vehicles (“ATVs”) are well known for travel over a wide variety of terrains, including over unpaved trails or fields, rocks, etc. Such vehicles are widely used in agriculture and forestry operations, as well as in safety operations such as for rugged mountain crossings. Such vehicles are also widely used for recreational enjoyment in natural, outdoor settings away from pavement. The suspension system of UVs and ATVs must be able to handle well during travel on such rough and rugged surfaces, typically including a shock absorber for each wheel as part of the suspension supporting the frame of the vehicle.

While able to travel over such rough and rugged surfaces, many UVs and ATVs are also driven over pavement and smooth dirt tracks, including at relatively high speed with high acceleration starts and high deceleration braking stops. In traditional shock absorbers used on UVs and ATVs, the ride characteristics of the shock absorber remain constant, and in particular the damping coefficient of the shock absorber remains constant regardless of the smoothness/roughness of the underlying road or path surface, and regardless of the load carried by the vehicle. The handling of the UV/ATV reflects its suspension. During high acceleration, the front of the traditional-suspension UV/ATV is raised; during heavy braking and fast deceleration, the front of the traditional-suspension UV/ATV is lowered or “nodded”. During sharp turning particularly at high speed, there is a large lateral inclination or roll of the traditional-suspension UV/ATV. The high degree of raising, nodding and roll of the traditional-suspension UV/ATV causes the riding comfort to be greatly reduced.

In order to increase the riding comfort level of a UV/ATV, some UVs and ATVs have including adjustable shock absorbers including magneto-rheological shock absorbers. The damper in magneto-rheological shock absorbers works based on pushing a magnetorheological fluid through one or more orifices. The (directional) viscosity of the magnetorheological fluid changes based on its magnetic field, usually applied and adjusted using an electromagnet. The damping characteristics of the shock absorber can thus be quickly adjusted and controlled by varying the power of the electrical signal driving the electromagnet. An example of a damper in such magneto-rheological shock absorbers is shown in U.S. Pat. No. 5,277,281 to Carlson, incorporated by reference.

If magneto-rheological shock absorbers are to be used on any vehicle, there must be some control methodology deciding how to adjust the electrical signal controlling the damping properties. In some vehicles, the control can be simply by the operator of the vehicle flipping a switch or other control in the cockpit of the vehicle, such as switching between a “luxury” or “comfort” mode and a “sport” or “aggressive” mode. In other vehicles, the control methodology can be semi- or fully-automated, based off sensed ride characteristics. An early example of a luxury vehicle using a semi-automated control methodology for magneto-rheological shock absorbers is shown in U.S. Pat. No. 5,390,121 to Wolfe, and an example of UVs and ATVs using a semi-automated control methodology for magneto-rheological shock absorbers is shown in U.S. Pat. No. 10,005,335 to Brady et al. Both U.S. Pat. Nos. 5,390,121 and 10,005,335 are incorporated by reference for their teaching of electronically controlled shock absorbers. However, both of these prior art proposed solutions are, in some aspects, overly complicated both in implementation (and thus cost) and in user-experience, often while not achieving the desired ride characteristics in a timely manner. Particularly when considering offroad vehicles such as UVs and ATVs, better solutions are needed.

### BRIEF SUMMARY OF THE INVENTION

The present invention is a method and system for controlling active shock absorbers (such as magneto-rheological shock absorbers) in an off road vehicle, together with an off road vehicle having the damping coefficients in its active shock absorbers so controlled. X- Y- and Z-signals from at least one accelerometer sensor are received and analyzed in an electronic control unit to make a vehicle travel status assessment. In one aspect, a recent history of Y-signals is also analyze to determine a vibration frequency of the vehicle relative to its natural suspension frequency. In another aspect, either a) two 3-axis accelerometer sensors are positioned high on the frame along a centerline of the vehicle, or b) a single accelerometer sensor is positioned just underneath the driver's seat, thereby reducing the cost of implementation while protecting the accelerometer sensor(s) from damage. In addition to considering vibration frequency, the electronic control unit preferably can determine the onset and conclusion an acceleration event, a deceleration event, a cornering event, or a jumping event, outputting signals used to adjust the damping coefficient of each of the active shock absorbers to provide better suspension characteristics for each event or series of vibrations and then returning to a steady state value.

### BRIEF DESCRIPTION OF THE DRAWINGS

FIG. 1 is a front perspective view of a portion of a frame and suspension of an off road vehicle, showing placement of two accelerometer sensors relative to two front magneto-rheological shock absorbers in a first embodiment of the present invention.

FIG. 2 is a rear perspective view of a portion of a frame and suspension of an off road vehicle, showing placement of two accelerometer sensors relative to two rear magneto-rheological shock absorbers in a first embodiment of the present invention.

FIG. 3 is an overhead plan view looking down on a portion of the frame, suspension and seats of an off road vehicle, showing placement of two accelerometer sensors for magneto-rheological shock absorbers in a second embodiment of the present invention.

FIG. 4 is a front perspective view of a portion of a frame, suspension and seats of an off road vehicle, showing placement of a single accelerometer sensor for magneto-rheological shock absorbers in a second embodiment of the present invention.

FIG. 5 is a flow chart explaining the preferred control methodology for the magneto-rheological shock absorbers used in the off road vehicle of the present invention.

While the above-identified drawing figures set forth preferred embodiments, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION OF THE PREFERRED EMBODIMENTS

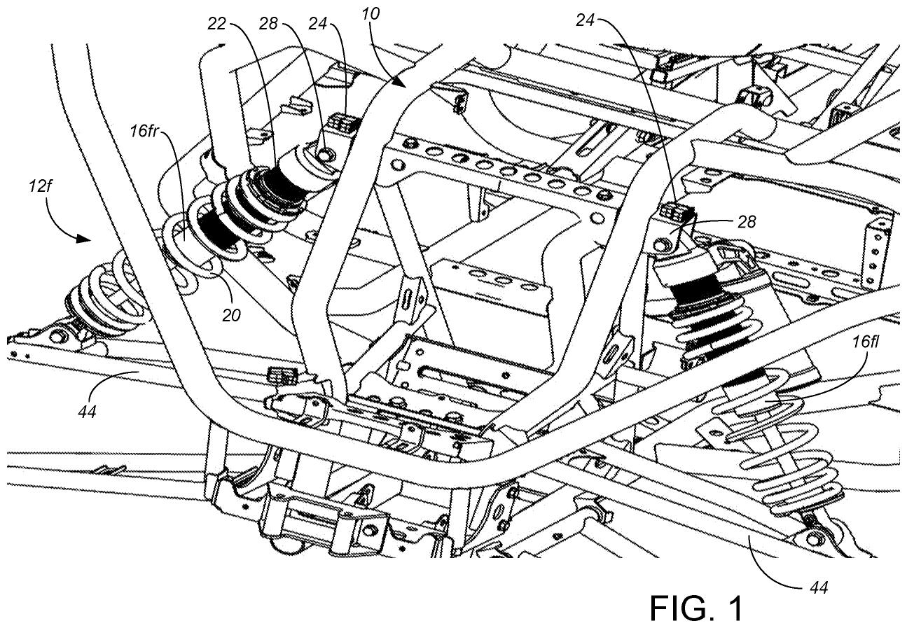

FIGS. 1-4 generally depict a frame 10, suspension 12f, 12r and roll-over protection system (“ROPS”) 14 of a UV or ATV which includes the present invention, including a front left magneto-rheological shock absorber 16fl, a front right magneto-rheological shock absorber 16fr, a rear left magneto-rheological shock absorber 16rl, and a rear right magneto-rheological shock absorber 16rr. This particular example of a frame 10 is for a side-by-side off road vehicle, with one seat 18d for a driver and one seat 18p next to the driver's seat 18d for a passenger. The present invention is, however, generally applicable to any UV or ATV, with various examples (including showing the exterior body panels) being shown in U.S. Pat. Nos. D844,492, D774,955, D751,467, D701,469, D694,671, D640,605, D640,604, D622,631, D597,890, D596,080, D595,613, D542,186 and U.S. Pat. Pub. Nos. 2019/0054797, 2019/0055875 and 2019/0144040, all incorporated by reference. Each shock absorber 16 includes a spring 20 and a damper 22.

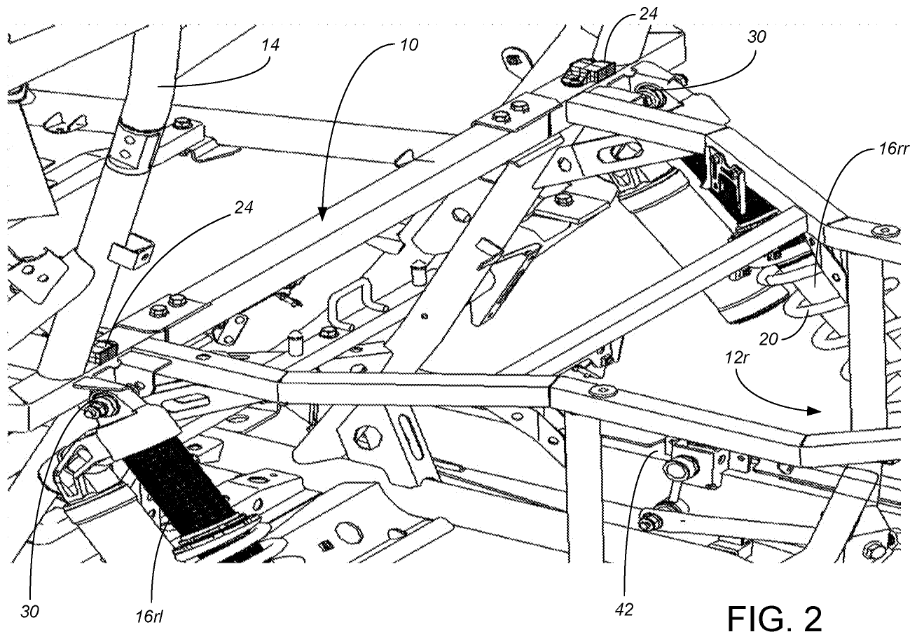

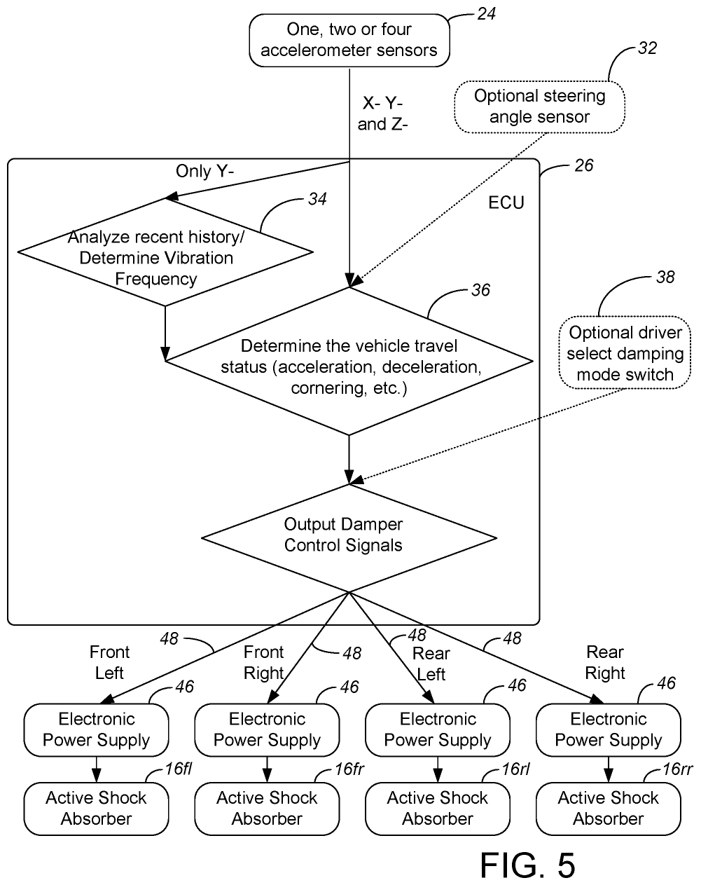

FIGS. 1 and 2 depict a first embodiment of the present invention, in which four 3-axis accelerometer sensors 24 can be used. When four accelerometer sensors 24 are used, each accelerometer sensor 24 is mounted on the frame 10 of the vehicle immediately above the location where the magneto-rheological shock absorber 16 is pivotally secured to the frame 10. This location can protect the accelerometers 24 better than under the chassis. Since the road conditions of UVs and ATVs are often very bad, such as wading and muddy mountains, protection of the accelerometers 24 from such bad conditions is particularly important. This positioning of multiple accelerometers 24, on the frame 10 at the upper ends of the electronically controlled shock absorbers 16, is largely as taught by U.S. Pat Nos. 5,390,121 and 10,005,335. Each accelerometer 24 is connected by a cable (not shown) to a single electronic control unit or ECU 26 (shown only in FIG. 5). The ECU 26 for the present invention includes a processor (not separately shown) for executing the control logic of FIG. 5, and can be mounted in any convenient, protected location on the vehicle. The cable (not shown) between the ECU 26 and each sensor 24 preferably provides a source voltage and ground to the sensor unit 24 as well as receiving the rapidly updated digital output values for each of the three axes from the accelerometer chip 24. Each accelerometer 24 outputs sensed X-, Y- and Z-acceleration values that are updated at least every 0.1 s, such as an accelerometer sampling rate of 50 or 100 Hz. As one alternative to cable connections between the ECU 26 and each accelerometer sensor 24, the accelerometer sensors 24 could communicate wirelessly with the ECU 26, but the preferred cable connections are currently less expensive and consume less power.

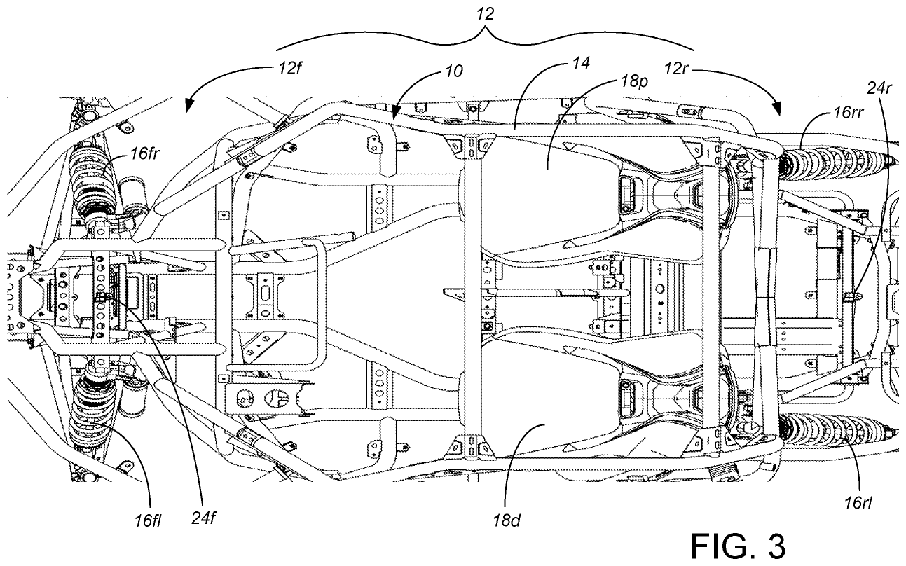

FIG. 3 depicts a second embodiment of the present invention, which is less expensive than the prior art of U.S. Pat Nos. 5,390,121 and 10,005,335 and less expensive than the first embodiment. Specifically, the second embodiment employs only two 3-axis accelerometer sensors 24f, 24r. When employing the control methodology of the present invention, two appropriately placed 3-axis accelerometer sensors 24 can be used to provide sufficient sensing data to control all four magneto-rheological shock absorbers 16. When only two 3-axis accelerometer sensors 24 are used, they are preferably positioned and longitudinally spaced as shown in FIG. 3, each on the frame 10 of the vehicle substantially along the longitudinal midline. As much as the frame construction permits, the front sensor 24d should be positioned between the front wheels (not shown) and the rear sensor 24r should be positioned between the rear wheels (not shown), but at higher elevations than the wheel axis. Similar to the four sensor 24 embodiment, each of the two sensors 24 should be mounted on top of a high section of the frame 10 so the accelerometers 24 can be better protected than under the chassis, particularly important for off road conditions. The most preferred embodiment places the front sensor 24f at a frame location higher than the top mounting locations 28 for each of the two front magneto-rheological shock absorbers 16fr, 16fl, roughly midway between the two front magneto-rheological shock absorbers 16fr, 16fl. With the most preferred frame 10 using a swing-type rear suspension 12r, the most preferred embodiment places the rear sensor 24r at a frame location higher than the top mounting locations 30 for each of the two rear magneto-rheological shock absorbers 16rl, 16rr, but substantially further rearward, i.e., at a longitudinal location roughly equal to the longitudinal location of the two rear wheels (not shown), at a lateral location roughly midway between the two rear wheels (not shown), but at a much higher elevation than the rotational axis of the two rear wheels (not shown).

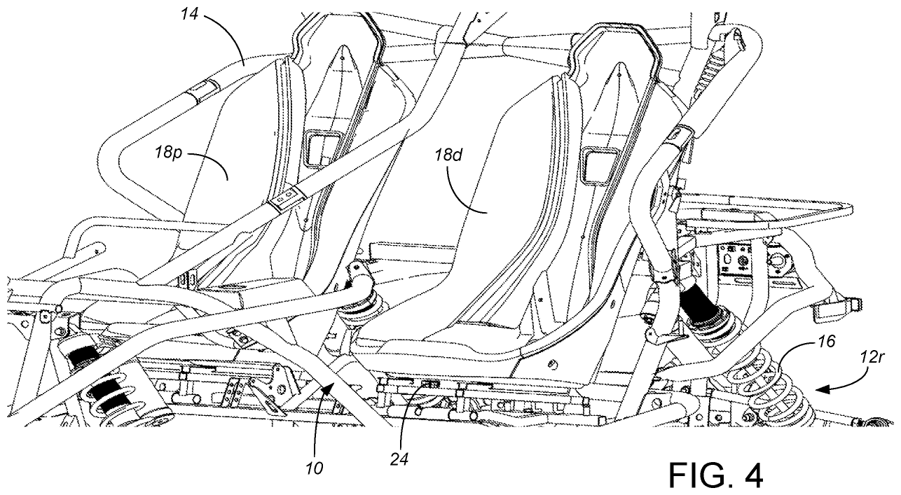

FIG. 4 depicts a third embodiment of the present invention, which is less expensive even than the second embodiment. Specifically, the third embodiment employs only one 3-axis accelerometer sensor 24. When employing the control methodology of the present invention, a single appropriately placed 3-axis accelerometer sensor 24 can be used to provide sufficient sensing data to control all four magneto-rheological shock absorbers 16. When only a single 3-axis accelerometer sensor 24 is used, it is preferably positioned as shown in FIG. 4. Specifically, the single accelerometer sensor 24 is mounted on the frame 10 of the vehicle immediately under the driver's seat 18d, but generally as high as the frame 10 and seat 18d will permit. This is a very protected location for the accelerometer 24, being structurally protected much the same as the driver is protected, and also will sense acceleration and vibration which matches very similarly to the acceleration and vibration felt by the driver. Use of a single appropriately placed 3-axis accelerometer sensor 24 in conjunction with the preferred control methodology described below has been found to obtain surprisingly good results. However, the two and four accelerometer sensor embodiments are more accurate at appropriately sensing the acceleration raising and deceleration nodding of the vehicle.

As an optional addition to any of these three embodiments, a steering angle sensor 32 (shown only in FIG. 5) can be added on the steering shaft (not shown). In addition to being in communication with each of the accelerometer sensors 24, the ECU 26 is also in electrically communication with the steering angle sensor 32. Use of the steering angle sensor 32 helps reduce processing time and further makes the control of the four magneto-rheological shock absorbers 16 more accurate and efficient. U.S. Pat. No. 5,390,121 to Wolfe is further incorporated by reference for its teaching of placement and use of steering angle sensors.

Regardless of whether the single sensor, two sensor or four sensor embodiments are used, the ECU 26 uses the magnitude of the X-, Y-, and Z-acceleration signals at any given time to determine vehicle suspension conditions. However, in addition to looking at instantaneous values, the ECU 26 also records and analyzes 34 the Y-axis signals of the accelerometer(s) 24 for a period of time, most preferably in a data register (not separately shown) storing at least the most recent 10 values, and more preferably storing from 0.5 to 10 seconds of data at the data output rate of the accelerometer (which may be, for instance, at least a 50 Hz sampling rate, meaning that the most recent at least 25-500 samples of Y-axis data would be stored and analyzed). The purpose of storing recent Y-axis data values is to attempt to identify and determine 34 the frequency of oscillation of the suspension 12 in the Y-direction. For instance, the ECU frequency assessment algorithm 34 can look at the time periods between consecutive Y-peaks of acceleration.

The X-, Y-, and Z-magnitudes and the Y-frequency assessment 34, as well as the optional steering angle data, are used in an algorithm 36 run within the processor of the ECU 26 to assess vehicle travel status. The vehicle travel status 36 is then used, preferably in conjunction with a vehicle mode 38 selected by the vehicle operator, in automatic and largely instantaneous adjustment 40 of the dampening characteristics of each of the magneto-rheological shock absorbers 16. Preferably the vehicle travel status assessment 36 is updated at the sampling rate of the accelerometers 24. The preferred magnetorheological shock absorbers can have their electrical control signal (and thereby their damping coefficient) changed very frequently and quickly, such as at up to 1 ms intervals. Importantly, the vehicle travel status assessment 36 must be updated an order of magnitude faster than the typical duration of acceleration, braking, turning and jumping events.

As additional options, additional signals existing within the vehicle can be used, or additional sensors can be used, to assess the call for power (i.e., how far the throttle pedal (not shown) is being pressed or throttle handle (not shown) is being pressed or turned, including, for instance, a throttle-by-wire signal) or braking (i.e., how far or hard the brake pedal (not shown) or brake handle (not shown) is being pressed, including, for instance, a brake fluid pressure signal). Like the steering angle data, these additional signals make the vehicle travel status assessment 36 more accurate. However, the present invention preferably avoids any use of a automobile pressure sensor (not shown) or a tire displacement sensor (not shown) on the suspension swing arm 42 or rocker arm 44. Such sensors (not shown) would be located on a lower position of vehicle which is much less protected than the sensors 24 of the present invention. As the off road vehicle travels runs over muddy roads, climbs over rocks, jumps, wades through puddles or streams and so on, the sensors 24 of the present invention are much less likely to be damaged than sensors (not shown) traditionally used to control active suspensions in on-road vehicles. The most preferred algorithm 36 to assess vehicle travel status can use only the X-, Y-, and Z-magnitudes and the Y-frequency assessment 34 from the 3-axis accelerometer data, including using only two or even only one appropriately located accelerometer 24, and obtain a relatively accurate vehicle travel status assessment.

In the preferred embodiment, the vehicle travel status can be assessed 36 as a value of either steady state, accelerating (at least on a yes/no basis, and more preferably the relative amount of acceleration, such as on a scale of 1 to 10), decelerating (at least on a yes/no basis, and more preferably the amount of deceleration, such as on a scale of 1 to 10) (alternatively, the acceleration/deceleration can be jointly assessed such as on a scale of −10 to 10), cornering (at least on a right/none/left basis, and more preferably the relative amount of cornering, such as on a scale of −10 to 10), vibration frequency (at least on a low frequency/high frequency basis, and more preferably on a scale of 1 to 10 from low frequency to high frequency) and jumping (at least on a yes/no basis, and more preferably on a scale of 1 to 10 based on the estimated liftoff velocity). The preferred algorithm 36 uses the X-, Y- and Z-signals to determine the sensed acceleration magnitude (such as using a pythagorean vector calculation, i.e., A=(X²+Y²+Z²)^{0.5}) as well as directionally specific acceleration magnitudes (such as using the X- (side to side) value to determine roll, and using the Z- (forward and backward) value to determine acceleration and braking), but only the Y-signal is analyzed to assess the presence of a characteristic vibration frequency 34.

In the most preferred embodiment, the damping force of each of the four magneto-rheological shock absorbers 16 can be adjusted from 700N to 4000N (measured at a piston speed is 0.3 m/s) or anywhere in between, based on an electrical control signal from 0 to 2 Amp DC. However, the damping force adjustment range can be different for different active shock absorber models and different for different vehicles. In general, when set to a lower (softer) value, the shock absorbers will allow greater suspension travel, good for travelling over bumpy terrain while minimizing the loss of ground contact and thus maximizing traction. In general, when set to a higher (stiffer) value, the shock absorbers will allow less suspension travel, good for even load distribution while cornering, braking or accelerating and good for reduced body roll, particularly for travel on smooth pavement. In all cases the active shock absorbers will have a difference between their minimum damping coefficient and their maximum damping coefficient, and be settable with an electrical control signal.

In the most preferred embodiment, each magneto-rheological shock absorber 16 has its own power supply 46 controlling power from the 12 V vehicle battery/power circuit and outputting current to the coil (not separately shown) of the magneto-rheological shock absorber 16, with the amperage of the current being based upon the control signal 48 provided from the ECU 26 to the power supply 46. For other power supplies or other active shock absorber models, different control signals can be used. In the most preferred embodiment, when the vehicle is assessed by the ECU 26 to be in steady state, a mid-range control signal 48 is output to the power supplies 46 of all four magneto-rheological shock absorbers 16, such that when desired the ECU 26 can either increase or decrease the damping coefficient of each of the four magneto-rheological shock absorbers 16 based upon the vehicle travel status assessment 36.

When the ECU 26 determines that the vehicle is accelerating, the ECU 26 controls the four magneto-rheological shock absorbers 16 so the damping coefficients of the two front magneto-rheological shock absorbers 16fl, 16fr of the vehicle becomes smaller relative to the damping coefficients of the two rear magneto-rheological shock absorbers 16rl, 16rr, preferably in proportion to the amount of acceleration. In the most preferred embodiment, this can be done simply by increasing the damping coefficient of the two rear magneto-rheological shock absorbers 16rl, 16rr. This adjustment tends to reduce the amount of raising of the nose during acceleration. When the ECU 26 determines that the vehicle is decelerating, the ECU 26 controls the four magneto-rheological shock absorbers 16 so the damping coefficients of the two front magneto-rheological shock absorbers 16fl, 16fr of the vehicle becomes larger relative to the damping coefficients of the two rear magneto-rheological shock absorber 16rl, 16rr, preferably in proportion to the amount of deceleration. In the preferred embodiment, this can be done simply by increasing the damping coefficient of the two front magneto-rheological shock absorbers 16fl, 16fr. This adjustment tends to reduce the amount of nodding of the vehicle during braking. When the ECU 26 determines that the vehicle is cornering, the ECU 26 controls the four magneto-rheological shock absorbers 16 so the damping coefficients of the two outer magneto-rheological shock absorbers 16 (either right or left, depending on the direction or cornering) of the vehicle become larger relative to the damping coefficients of the two inner magneto-rheological shock absorbers 16, preferably in proportion to the amount of cornering. In the preferred embodiment, this can be done simply by increasing the damping coefficient of the two outer magneto-rheological shock absorbers 16. This adjustment tends to reduce the amount of roll of the vehicle during cornering. In each case, as ECU 26 determines that the acceleration or deceleration or cornering event has concluded, the ECU 26 returns the damping coefficients of the magneto rheological shock absorbers 16 back to their steady state values.

Vibration frequency is assessed 34 as low or high relative to the natural suspension frequency of the vehicle. The natural suspension frequency of the vehicle is based on the vehicles mass and spring rate, in accordance with the formula

f=1/(2π)*(K/M)^{0.5}

where
f=suspension frequency (Hz)
K=spring rate (N/m)
M=mass (Kg)
   The natural suspension frequency of all-terrain vehicles is generally between 1-3 Hz and can be adjusted according to different vehicle models (different masses) and different springs in the shock absorbers (different spring rates). A sensed vibration frequency less than or equal to the natural suspension frequency is considered to be “low”, and a sensed vibration frequency greater than the natural suspension frequency is considered “high”. Low frequency vibrations are characteristic of travel over smooth dirt or pavement. High frequency vibrations are characteristic of off-road travel over gravel, dirt trails, or rocky fields. When the ECU 26 determines that the vehicle is vibrating at a high frequency, the ECU 26 controls all four magneto-rheological shock absorbers 16 so the damping coefficients are reduced, preferably in proportion to how low the determined vibration frequency is relative to the natural suspension frequency. When the ECU 26 determines that the vehicle is vibrating at a low frequency, the ECU 26 controls all four magneto-rheological shock absorbers 16 so the damping coefficients are increased, preferably in proportion to how high the determined vibration frequency is relative to the natural suspension frequency.

When the ECU 26 determines that the vehicle jumps off the ground, the ECU 26 controls all four magneto-rheological shock absorbers 16 so the damping coefficients are increased. This adjustment tends to reduce the likelihood of the vehicle bottoming out when landing. When the jump is over, the ECU 26 controls all four magneto-rheological shock absorbers 16 so the damping coefficients are reduced toward their steady state values.

In the preferred embodiment of the present invention, the control of the damping characteristics is semi-automated rather than fully-automated, and the driver can also select various modes of vehicle operation which also influence the damping characteristics. For instance, the preferred UV/ATV allows the driver to select modes of “standard”, “racing” and “climbing” via a switch 38 (shown only in FIG. 5) in the cockpit of the vehicle. In “racing” mode, best for when the vehicle will be driven at relatively high speed over relatively smooth dirt paths, the steady state suspension is stiffer than in “standard mode”, i.e., the starting point for the damping coefficients of all four magneto-rheological shock absorbers 16 is higher even before any adjustment is made for the vehicle travel status assessment 36 and/or vibration frequency 34. The stiffer suspension results in additional vehicle traction when driving over smooth surfaces. In “climbing” mode, best for when the vehicle will be driven at relatively low speed over boulders, logs and other obstacles, the steady state suspension is lower than in “standard mode”, i.e., the starting point for the damping coefficients of all four magneto-rheological shock absorbers 16 is lower even before any adjustment is made for the vehicle travel status assessment 36 and/or vibration frequency 34. The softer suspension results in additional vehicle traction when driving over heavily undulating surfaces.

Because the vehicle travel status assessment 36 is updated at least order of magnitude faster than the typical duration of acceleration, braking, turning and jumping events, the damping characteristics of the various shock absorbers 16 are adjusted during the onset of any acceleration, braking, turning and jumping event, typically well before the peak change in acceleration (jerk in any direction) is obtained. The method of the present invention thus stabilizes the suspension response and improves the riding comfort of the all-terrain vehicle, significantly reducing jerks that would otherwise be felt by the driver and/or passenger. Additionally, braking and turning stability is better and driving is safer. The implementation cost of the present invention is lower than prior art active suspension implementations, and the system is reliable and robust and unlikely to be damaged during use of the off road vehicle.

Although the present invention has been described with reference to preferred embodiments, workers skilled in the art will recognize that changes may be made in form and detail without departing from the spirit and scope of the invention

1. An active shock absorbing system for an off road vehicle, comprising:
at least one 3-axis accelerometer sensor;
an electronic control unit receiving X- Y- and Z-signals from the accelerometer sensor,
a front left active shock absorber, a front right active shock absorber, a rear left active shock absorber and a rear right active shock absorber all as part of the suspension of the off road vehicle;
wherein the electronic control unit analyzes a recent history of Y-signals to determine a vibration frequency, the electronic control unit outputting signals to control the damping coefficient of each of the active shock absorbers in a way which varies based on magnitude of the X- Y- and Z-signals from the accelerometer sensor and based on the determined vibration frequency.

2. The active shock absorbing system of claim 1, wherein the vibration frequency is determined to be low if it is lower than a natural suspension frequency of the vehicle and determined to be high if it is higher than the natural suspension frequency of the vehicle, wherein the electronic control unit outputs signals to reduce the damping coefficient of each of the active shock absorbers when the vibration frequency is high and wherein the electronic control unit outputs signals to increase the damping coefficient of each of the active shock absorbers when the vibration frequency is low.

3. The active shock absorbing system of claim 1, wherein the electronic control unit determines when the vehicle accelerates, wherein the electronic control unit outputs signals to increase the damping coefficient of the rear left active shock absorber and to increase the damping coefficient of the rear right active shock absorber immediately following onset of an acceleration event.

4. The active shock absorbing system of claim 1, wherein the electronic control unit determines when the vehicle decelerates, wherein the electronic control unit outputs signals to increase the damping coefficient of the front left active shock absorber and to increase the damping coefficient of the front right active shock absorber immediately following onset of a deceleration event.

5. The active shock absorbing system of claim 1, wherein the electronic control unit determines when the vehicle corners and a direction of cornering, wherein the electronic control unit outputs signals to increase the damping coefficient of two outside active shock absorbers immediately following onset of a cornering event.

6. The active shock absorbing system of claim 5, further comprising a steering angle sensor providing a steering angle signal to the electronic control unit, the electronic control unit using the steering angle signal to more accurately determine when the vehicle corners and the direction of cornering.

7. The active shock absorbing system of claim 1, wherein the electronic control unit determines when the vehicle jumps off the ground, wherein the electronic control unit outputs signals to increase the damping coefficient of all four active shock absorbers immediately following onset of a jumping event.

8. The active shock absorbing system of claim 1, using either only one 3-axis accelerometer sensor or only two 3-axis accelerometer sensors.

9. The active shock absorbing system of claim 1, wherein at least one 3-axis accelerometer sensor is positioned beneath a seat of the off road vehicle.

10. The active shock absorbing system of claim 1, further comprising a driver select damping mode switch providing a mode signal to the electronic control unit, the electronic control unit adjusting the output signals to control the damping coefficient of each of the active shock absorbers in part based upon the mode signal.

11. The active shock absorbing system of claim 10, wherein the electronic control unit determines a steady state and outputs a steady state output signal to each of the active shock absorbers based upon the mode signal, and wherein the electronic control unit returns the damping coefficient of each of the active shock absorbers to a steady state value upon determining a completion of any of an acceleration event, a deceleration event, a cornering event, or a jumping event.

12. An off road vehicle having an active shock absorbing system, comprising:
either only one 3-axis accelerometer sensor or only two 3-axis accelerometer sensors;
an electronic control unit receiving X- Y- and Z-signals from the one or two accelerometer sensors,
a front left active shock absorber, a front right active shock absorber, a rear left active shock absorber and a rear right active shock absorber;
wherein the electronic control unit outputs signals to control the damping coefficient of each of the active shock absorbers in a way which varies based on the X- Y- and Z-signals from the one or two accelerometer sensors;

13. The off road vehicle of claim 12 further comprising a seat and having only one 3-axis accelerometer sensor, wherein the 3-axis accelerometer sensor is positioned beneath a seat of the off road vehicle.

14. The off road vehicle of claim 13, further comprising a frame supporting the seat, wherein the seat is a driver's seat and further comprising a passenger's seat, wherein the 3-axis accelerometer sensor is positioned on the frame beneath the driver's seat of the off road vehicle.

15. The off road vehicle of claim 12 further comprising a frame, with each of the active shock absorbers having an upper end connected to the frame, the off road vehicle having only a front 3-axis accelerometer sensor and a rear 3-axis accelerometer sensor each positioned higher than the upper ends of the active shock absorbers, wherein the front 3-axis accelerometer sensor is positioned on the frame along a mid-line of the vehicle between the upper end of the front left active shock absorber and the upper end of the front right active shock absorber, and wherein the rear 3-axis accelerometer sensor is positioned on the frame along a mid-line of the vehicle rearward of the front 3-axis accelerometer.

16. The off road vehicle of claim 12, wherein the electronic control unit analyzes a recent history of Y-signals to determine a vibration frequency, the electronic control unit outputting signals to control the damping coefficient of each of the active shock absorbers in a way which varies based on magnitude of the X- Y- and Z-signals from the one or two accelerometer sensors and based on the determined vibration frequency.

17. The active shock absorbing system of claim 16, wherein the vibration frequency is determined to be low if it is lower than a natural suspension frequency of the vehicle and determined to be high if it is higher than the natural suspension frequency of the vehicle, wherein the electronic control unit outputs signals to reduce the damping coefficient of each of the active shock absorbers when the vibration frequency is high and wherein the electronic control unit outputs signals to increase the damping coefficient of each of the active shock absorbers when the vibration frequency is low.

18. A method of controlling active shock absorbers in an off road vehicle, comprising:
receiving, within an electronic control unit, X- Y- and Z-signals from at least one accelerometer sensor positioned either under a seat of the vehicle or along a longitudinal midline of the off road vehicle;
analyzing, within the electronic control unit, a recent history of Y-signals to determine a vibration frequency of the vehicle relative to a natural suspension frequency of the off road vehicle; and
outputting, from the electronic control unit, control signals to each of a front left active shock absorber, a front right active shock absorber, a rear left active shock absorber and a rear right active shock absorber all as part of the suspension of the off road vehicle, the control signals being used to adjust the damping coefficient of each of the active shock absorbers in a way which varies based on magnitude of the X- Y- and Z-signals from the accelerometer sensor and based on the determined vibration frequency.

19. The method of claim 18, wherein the vibration frequency is determined to be low if it is lower than a natural suspension frequency of the vehicle and determined to be high if it is higher than the natural suspension frequency of the vehicle, wherein the electronic control unit outputs signals to reduce the damping coefficient of each of the active shock absorbers when the vibration frequency is high and wherein the electronic control unit outputs signals to increase the damping coefficient of each of the active shock absorbers when the vibration frequency is low.

20. The method of claim 18, wherein the electronic control unit can assess an onset of an acceleration event, a deceleration event, a cornering event, or a jumping event, wherein the control signals are collectively used for:
following onset of an acceleration event, resisting raising of a nose of the off road vehicle during the acceleration event;
following onset of a deceleration event, resisting nodding of the off road vehicle during the deceleration event;
following onset of a cornering event, resisting roll of the off road vehicle during the cornering event;
following onset of a jumping event, resisting bottoming out of the off road vehicle upon landing; and
following conclusion of an acceleration event, a deceleration event, a cornering event, or a jumping event, returning the damping coefficient of each of the active shock absorbers to a steady state value.
